(19) United States
(12) Patent Application Publication
(10) Pub. No.: US 2008/0186210 A1
(43) Pub. Date: Aug. 7, 2008

(54) REAL-IMAGE NAVIGATION APPARATUS

(75) Inventor: Chao-Hsien Tseng, Taoyuan (TW)

Correspondence Address: LAW OFFICES OF MIKIO ISHIMARU, 333 W. EL CAMINO REAL, SUITE 330, SUNNYVALE, CA, 94087, US

(73) Assignee: MITAC INTERNATIONAL CORPORATION, Taoyuan (TW)

(21) Appl. No.: 11/775,625

(22) Filed: Jul. 10, 2007

(30) Foreign Application Priority Data
Feb. 2, 2007 (TW) 096103831

(51) Int. Cl. G08G 1/123

(52) U.S. Cl. 340/995.26; 701/211

(57) ABSTRACT

The invention provides a real-image navigation apparatus capable of being mounted on a vehicle having transparent equipment (windows) installed therein, including an image-capturing unit adapted to instantly capture images of a road in front of a vehicle; a satellite navigation system adapted to navigate and generate navigation routes and driver-assisting navigation information; a comparing unit adapted to compare and determine the consistency between obtained images captured by the image-capturing unit and road parameters of mapping information pre-stored in the system, and further output three-dimensional navigation routes planned by cooperating with the system; and a see-through display unit mounted on transparent equipment installed within the vehicle to display real-time driver-assisting navigation information and 3-D navigation routes outputted by the comparing unit to the user/driver, thereby presenting useful navigation data and related geographical information without overly diverting eye focus or obstructing the driver's view, and thus increase driving safety.

### BACKGROUND OF THE INVENTION

1. Field of the Invention

The present invention relates to a real-image navigation apparatus, and more particularly, to a real-image navigation apparatus applicable in motor vehicles having transparent equipment (windows) installed therein and capable of outputting three-dimensional navigation routes on a transparent display unit.

2. General Background

Vehicle navigation systems are well known and are being used for various mobile applications. Conventional navigation systems that give guidance along a route to a destination detect the current position of a vehicle and display a map corresponding to the current position. Guidance is then given relating to intersections and relevant objects along the route.

However, the display screen utilized in conventional vehicle navigation systems is often less than ideal due to the limited space of the control area located in front of the front seats of a vehicle, and, moreover, it distracts the driver's attention off the road or diverts eye focus in order to view information, driving directions and maps displayed thereon, thereby increasing the hazards and risks while operating a vehicle.

Addressing the hazards of viewing navigation information while driving, some modern vehicle navigation kits offer wide remote LCD displays, as shown in FIG. 1, that are installed on the control area or the dashboard to enable the driver to view the information with reduced need to divert the eyes. However, the large remote LCD displays have not solved the need for drivers to change eye focus between long and short focal ranges, the need to view that data in a different lighting conditions, and the diversion caused in the process. Therefore, there is still a higher than desired diversion of attention and associated safety risks when viewing navigational information while driving even with such large remote displays.

As such, it is desirable to develop an improved navigation mechanism capable of overcoming the drawbacks of the prior art as discussed above.

### SUMMARY OF THE INVENTION

The present invention provides a navigation system capable of being mounted on a vehicle in such a way that it provides ease of viewing, and diminishes at least some of the disadvantages associated with prior methods for displaying mobile and navigation information in a mobile environment. Moreover, it enables the navigation system to be easily and seamlessly utilized with mobile applications.

A primary objective of the present invention is to provide a real-image navigation apparatus for increasing driving safety.

Another objective of the present invention is to provide a real-image navigation apparatus capable of outputting 3-D navigation routes to a user of a vehicle navigation system.

In order to achieve the above and other objectives, the present invention provides a real-image navigation apparatus applicable in a motor vehicle having transparent equipment such as windows installed therein. The real-image navigation apparatus includes an image-capturing unit adapted to capture images of a road in front of a motor vehicle in a real-time manner; a satellite navigation system adapted to navigate the vehicle and generate appropriate navigation routes and driver-assisting navigation information; a comparing unit adapted to compare and determine the consistency between the obtained images of a road in front of the vehicle captured by the image-capturing unit and road parameters of the mapping information pre-stored in the satellite navigation system, and further output three-dimensional navigation routes generated by cooperating with the satellite navigation system; and a transparent display unit mounted on transparent equipment such as a window installed within the vehicle to timely display thereon to the user the driver-assisting navigation information generated by the system and the 3-D navigation routes output by the comparing unit.

In the system, when the comparing unit compares and then determines that consistency exists between the captured images in front of a vehicle and the pre-stored road parameters of the mapping information, it outputs 3-D navigational routes planned by the satellite navigation system according to the obtained images of a road in front of a vehicle. On the other hand, if the comparing unit detects inconsistency between the captured images in front of a vehicle and the pre-stored road parameters of the mapping information, it proceeds to adjust and correct the mapping data according to the obtained images, and by cooperating with the satellite navigation system, further output 3-D navigational routes of a planned and target route.

The image-capturing unit is a picture-taking camera.

The satellite navigation system at least consists of an input module for allowing a user to set navigation goals; a Global Positioning System Module (GPS Module) for receiving satellite positioning signals; a database for storing mapping data therein; and a data processing module electrically connected to the input module, the GPS Module, and the database for planning navigation routes according to navigation goals, satellite positioning signals and mapping data, and further executing a navigation function and generating driver-assisting navigation information.

The transparent display unit is a Transparent Organic Light-Emitting Diode Display (T OLED).

The transparent equipment installed within the vehicle includes the windscreen (windshield) and vehicle windows.

In summary, the characteristics of the present invention include the utilization of an image-capturing unit to correspondingly face and instantly capture images of a road in front of a motor vehicle in a real-time manner; the provision of a satellite navigation system to navigate the vehicle and generate planned navigation routes and driver-assisting navigation information; a comparing unit adapted to compare and determine consistency between the obtained images of a road in front of the vehicle captured by the image-capturing unit and road parameters of mapping information that are pre-stored in a satellite navigation system, and further output three-dimensional navigation routes planned by cooperating with the satellite navigation system; and a transparent display unit mounted on a transparent equipment installed within the vehicle to timely display to the user the driver-assisting navigation information generated by the satellite navigation system and the 3-D navigation routes output by the comparing unit, thereby presenting useful direction data and related geographical information without overly diverting eye focus or obstructing the driver's view, thus increasing driving safety as a result.

### BRIEF DESCRIPTION OF DRAWINGS

The real-image navigation apparatus of the present invention can be more fully understood by reading the following detailed description of the preferred embodiment, with reference made to the accompanying drawings, wherein:

FIG. 1 (PRIOR ART) is a perspective view illustrating a conventional navigation system;

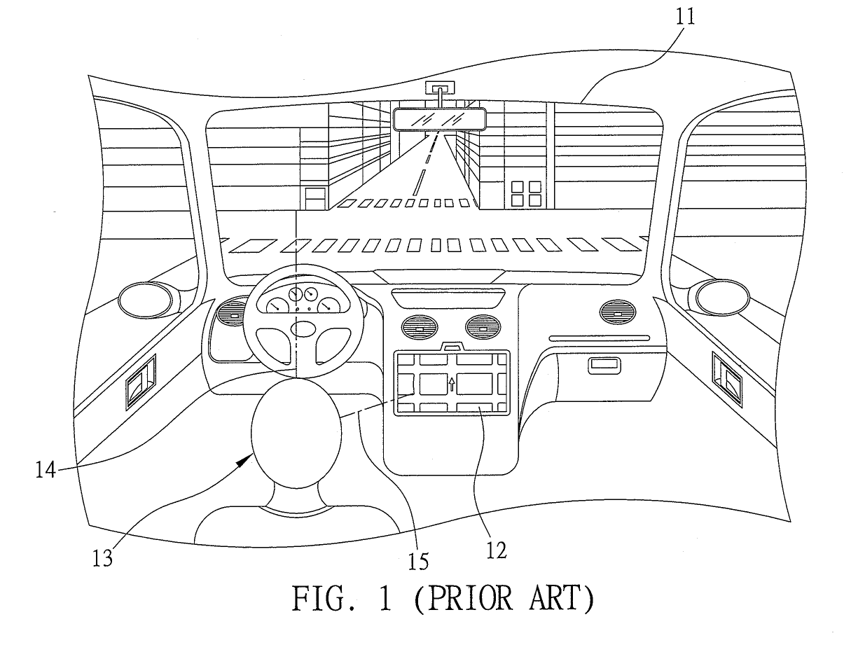

FIG. 2 is a block diagram illustrating a first preferred embodiment of the real-image navigation apparatus according to the present invention; and

FIG. 3 is a perspective view illustrating the preferred embodiment shown in the block diagram of FIG. 2 of the real-image navigation apparatus according to the present invention.

### DETAILED DESCRIPTION OF THE PREFERRED EMBODIMENT

The present invention is described in the following so that one skilled in the pertinent art can easily understand other advantages and effects of the present invention. The present invention may also be implemented and applied according to other embodiments, and the details may be modified based on different views and applications without departing from the spirit of the invention.

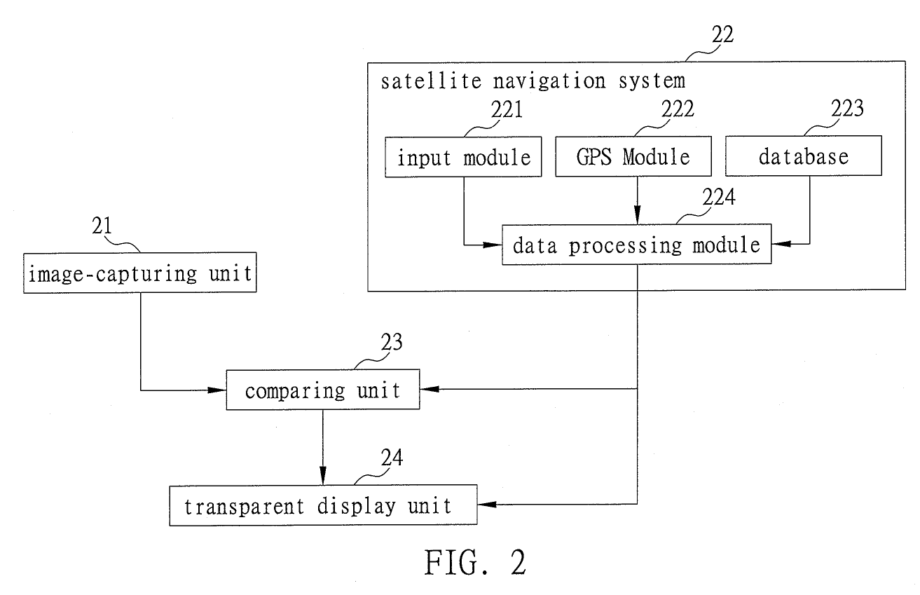

FIG. 2 is a block diagram depicting a preferred embodiment of the real-image navigation apparatus of the invention. The real-view navigation apparatus is applicable to a motor vehicle having transparent equipment installed therein. In this embodiment, the transparent equipment installed within the vehicle includes the windscreen (windshield) and vehicle windows.

The real-image navigation apparatus includes an image-capturing unit 21 installed within the motor vehicle and adapted to capture images of a road in front of the mobile vehicle in a real-time manner; a satellite navigation system 22 installed within a mobile vehicle and provided with pre-stored mapping information to allow a user to set navigation goals in order to generate target navigation routes and driver-assisting navigation information; a comparing unit 23 installed in the vehicle and electrically connected to the image-capturing unit 21 and the satellite navigation system 22 to compare and determine consistency between the obtained images of a road in front of the vehicle captured by the image-capturing unit 21 and road parameters of the mapping information pre-stored in the satellite navigation system 22, wherein, if the comparing unit 23 detects consistency therebetween it outputs 3-D navigation routes planned by the satellite navigation system according to the obtained images, whereas, if inconsistency is detected therebetween, it proceeds to adjust and correct the mapping data according to the obtained images, and by cooperating with the satellite navigation system 22, further output 3-D navigation routes of a target planned route; and a transparent display unit 24 mounted on transparent equipment installed within the vehicle and electrically connected to the satellite navigation system 22 and the comparing unit 23, to timely display to the user the driver-assisting navigation information generated by the satellite navigation system 22 and 3-D navigation routes output by the comparing unit 23.

In this embodiment, the image-capturing unit 21 is a picture-taking camera. The satellite navigation system 22 at least consists of an input module 221 for allowing a user to set navigation goals; a Global Positioning System Module (GPS Module) 222 for receiving satellite positioning signals; a database 223 for storing mapping data therein; and a data processing module 224 electrically connected to the input module 221, the GPS Module 222, and the database 223 for planning navigation routes according to the target navigation goals, satellite positioning signals and mapping data, and further executing a navigation function and generating driver-assisting navigation information.

Moreover, the road parameters include the dimensions and contours of a road. The transparent display unit is a Transparent Organic Light-Emitting Diode Display (T OLED).

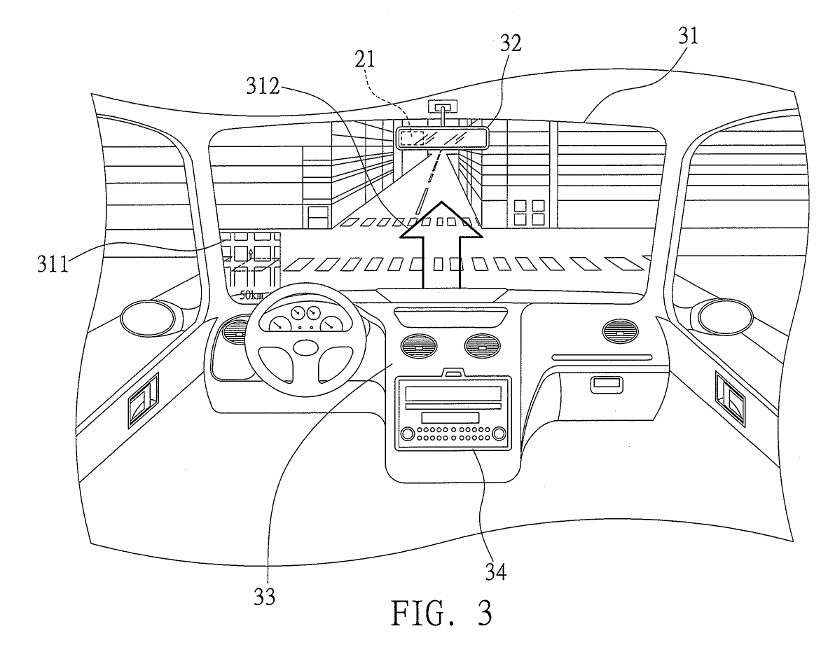

FIG. 3 shows a perspective view of the preferred embodiment of the real-image navigation apparatus according to the present invention. As illustrated, the image-capturing unit 21 may be installed on the backside (road-facing side) of the rear-view mirror 32 installed within a vehicle to correspondingly and instantly capture images of a road in front of the vehicle. The satellite navigation system 22 and the comparing unit 23 of the real-image navigation apparatus may be integrated into a single electronic device 34 to be installed within the control area of a vehicle. The transparent display unit 24 mounted on transparent equipment of the vehicle such as a windshield may be integrated with said transparent equipment such as the windshield of the vehicle to provide an assisting navigation information zone 311 and a 3-D navigation route zone 312, wherein the assisting navigation information zone 311 is used to timely display the driver-assisting navigation information generated by the satellite navigation system 22, and the 3-D navigation route zone 312 is used to timely display the 3-D navigation route output by the comparing unit 23.

In conclusion, the present invention is characterized by the use of an image-capturing unit to capture images in real-time of a road in front of a motor vehicle, so as to compare the obtained images with mapping data pre-stored in a satellite navigation system, and further output corresponding three-dimensional navigation routes; and a transparent display unit that is mounted on a window installed within the vehicle to timely display to the user the driver-assisting navigation information, thereby enabling the user to view useful direction data and related geographical information without overly diverting eye focus or obstructing the driver's view, thus increasing driving safety.

It will be understood that the invention may be embodied in other specific forms without departing from the spirit or central characteristics thereof. The present examples and embodiment, therefore, are to be considered in all respects as illustrative and not restrictive, and the invention is not to be limited to the details given herein for the preferred embodiment.

What is claimed is:

1. A real-image navigation apparatus applicable in a motor vehicle having transparent equipment installed therein, the real-image navigation apparatus at least comprising:
an image-capturing unit adapted to correspondingly face and instantly capture images of a road in front of a mobile vehicle in a real-time manner;
a satellite navigation system installed within the vehicle and provided with mapping information to navigate the vehicle and generate appropriate navigation routes and driver-assisting navigation information;
a comparing unit installed within the vehicle and adapted to compare and determine consistency between the obtained images of a road in front of the vehicle captured by the image-capturing unit and road parameters of the mapping information pre-stored in the satellite navigation system, and further output three-dimensional navigation routes generated by cooperating with the satellite navigation system; and
a transparent display unit mounted on a transparent equipment installed within the vehicle to display thereon in real time to the user the driver-assisting navigation information generated by the system and the 3-D navigation routes output by the comparing unit.

2. The real-image navigation apparatus of claim 1, wherein, when the comparing unit compares and then determines that a consistency exists between the captured images in front of a vehicle and the pre-stored road parameters of the mapping information, it outputs 3-D navigational routes generated by the satellite navigation system according to the obtained images; and, conversely, if the comparing unit detects an inconsistency between the captured images in front of a vehicle and the pre-stored road parameters of the mapping information, it proceeds to adjust and correct the mapping data according to the obtained images, and by cooperating with the satellite navigation system, further output 3-D navigational routes of a planned and target route.

3. The real-image navigation apparatus of claim 1, wherein the image-capturing unit is a picture-taking camera.

4. The real-image navigation apparatus of claim 1, wherein the satellite navigation system at least consists of:
an input module for allowing a user to set navigation goals;
a Global Positioning System Module (GPS Module) for receiving satellite positioning signals;
a database for storing mapping data therein; and
a data processing module electrically connected to the input module, the GPS Module, and the database for planning navigation routes according to navigation goals, satellite positioning signals and mapping data, and further executing a navigation function and generating driver-assisting navigation information.

5. The real-image navigation apparatus of claim 1, wherein the road parameters include the dimensions and contours of a road.

6. The real-image navigation apparatus of claim 1, wherein the transparent display unit is a Transparent Organic Light-Emitting Diode Display (T OLED).

7. The real-image navigation apparatus of claim 1, wherein the transparent equipment installed within the vehicle includes the windscreen (windshield) and vehicle windows.
